(19) United States
(12) Patent Application Publication
(10) Pub. No.: US 2026/0056868 A1
(43) Pub. Date: Feb. 26, 2026

(54) BUS LOAD MONITORING IN A MEMORY SUB-SYSTEM CONTROLLER

(71) Applicant: Micron Technology, Inc., Boise, ID (US)

(72) Inventor: Andrei Konan, Meridian, ID (US)

(21) Appl. No.: 18/809,941

(22) Filed: Aug. 20, 2024

(51) Int. Cl. G06F 11/34; G06F 9/32; G06F 11/30

(52) U.S. Cl. CPC G06F 11/349; G06F 9/321; G06F 11/3027

(57) ABSTRACT

An integrated circuit includes a memory bus coupled to a random access memory (RAM). A plurality of ports enable hardware logic to access the RAM over the memory bus. A central processing unit (CPU) is coupled to the memory bus. A first hardware logic module is coupled to a first port, of the plurality of ports, to share access to the memory bus with the CPU. A plurality of hardware registers, coupled to the plurality of ports, include a first hardware register to store a number of accesses, by the first hardware logic module, to the memory bus over the first port.

### TECHNICAL FIELD

Embodiments of the disclosure generally relate to memory sub-systems, and more specifically, relate to bus load monitoring in a memory sub-system controller.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The present disclosure will be understood more fully from the detailed description given below and from the accompanying drawings of various embodiments of the disclosure.

FIG. 1 illustrates an example computing system that includes a memory sub-system in accordance with some embodiments of the present disclosure.

FIG. 2 is a block diagram illustrating a computing system for monitoring and exporting system state information, in accordance with some embodiments.

FIG. 3A is a block diagram illustrating a computing system that includes an integrated circuit (IC) implementing a memory sub-system controller configured to monitor a memory bus, in accordance with some embodiments.

FIG. 3B is a block diagram illustrating a computing system that includes an integrated circuit (IC) implementing a memory sub-system controller configured to monitor a memory bus, in accordance with further embodiments.

FIG. 4 is a block diagram of an example computer system in which embodiments of the present disclosure can operate.

### DETAILED DESCRIPTION

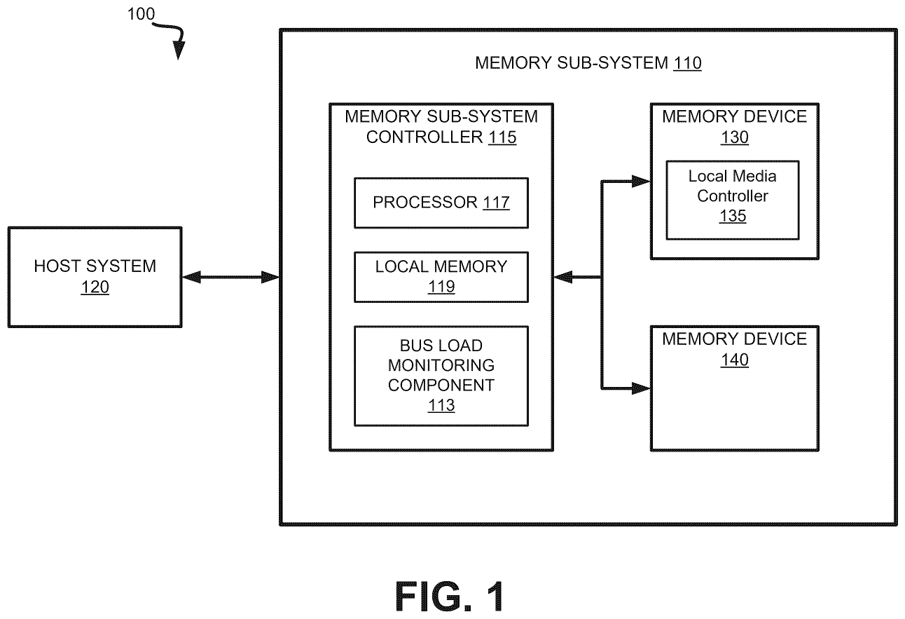

Aspects of the present disclosure are directed to monitoring internal resources in memory sub-systems. A memory sub-system can be a storage device, a memory module, or a combination of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

Memory access operations can be performed by the memory sub-system. The memory access operations can be host-initiated or memory sub-system controller-initiated operations. For example, the host system can initiate a memory access operation (e.g., write operation, read operation, erase operation, etc.) on a memory sub-system. The host system can send memory access commands (e.g., write command, read command) to the memory sub-system, such as to store data on a memory device at the memory sub-system and to read data from the memory device on the memory sub-system. The data to be read or written, as specified by a host request, is hereinafter referred to as “host data.” A host request can include logical address information (e.g., logical block address (LBA), namespace) for the host data, which is the location the host system associates with the host data. The logical address information can be part of metadata for the host data. Metadata can also include error handling data (e.g., ECC codeword, parity code), data version (e.g. used to distinguish age of data written), valid bitmap (which LBAs or logical transfer units contain valid data), and the like. Memory access operations initiated by the memory sub-system controller can relate to maintenance operations, such as garbage collection, wear leveling, bad block management, block refresh operations, and the like.

Certain memory sub-system controllers are implemented on an integrated circuit (IC) chip that includes a combination of hardware logic and firmware, which is configured to operate as fast as possible to handle the above-mentioned memory access operations. For this reason, controller chips such as this may include central processing units (CPUs) (or other processing units executing firmware) that share a memory bus with hardware logic modules, e.g., application-specific integrated circuit (ASIC)-based modules. The memory bus can, for example, enable access to data stored in a random access memory (RAM) such as static RAM (SRAM) or dynamic RAM (DRAM), either of which can be shared between the CPUs and the hardware logic units.

The challenge with memory bus sharing is that, particularly at high speed operations after tape-out of the IC chip, it is difficult to troubleshoot latencies (or related issues) with firmware operation of the CPUs. More specifically, latencies in certain memory access operations performed by a CPU could be attributable to shared RAM memory accesses by one or more hardware logic units to which the CPU has no visibility or knowledge. For example, accesses via the memory bus to the RAM by the one or more hardware logic units increases the bus load in way that is transparent to the CPU. When gathering and analyzing performance-related data, firmware engineers can find it difficult to troubleshoot firmware issues when certain latencies may be caused by hardware that lies outside of the CPUs on the IC chip. These difficulties are amplified after tape-out of the IC chip because external CPU memory accesses are no longer measurable in other environments, such as in simulation or in a field-programmable gate array (FPGA), which may be employed only during the design phase of the IC chip.

Aspects of the present disclosure address the above-noted and other deficiencies by configuring the IC chip controller with hardware registers adapted to monitor ports, which are employed to enable access, by the hardware logic modules, to the shared memory bus. This monitoring would thus include tracking, such as with hardware counters, how many accesses are being made by individual hardware logic modules over time via the ports. Some hardware registers such as control and status registers (CSRs) can operate as performance counters and are accessible to CPU firmware of the controller, enabling the CPUs to retrieve the number of accesses as performance data that can be analyzed together with performance data associated directedly with CPU operations. In this way, the CPU firmware gains visibility to the latencies that may be attributable to certain hardware logic modules due to sharing the memory bus of the RAM that the controller uses during memory access operations.

In various embodiments, for example, an integrated circuit (e.g., IC chip controller) includes a memory bus coupled to a random access memory (RAM). The integrated circuit can also include a plurality of ports that can enable hardware logic to access the RAM over the memory bus. Each of a plurality of hardware logic modules can be coupled to a port of the plurality of ports, which ports enable shared access to the memory bus. The integrated circuit can also include one or more CPUs, each of which is coupled to the memory bus, making the memory bus shared between the CPUs and the hardware logic modules. The integrated circuit can also include a plurality of hardware registers coupled to the plurality of ports. In embodiments, each of these hardware registers stores a number of accesses by a particular hardware logic module through a particular port of the plurality of ports. In this way, the hardware registers can track the number of memory bus accesses over each port on a per-hardware logic module basis. In some embodiments, the registers are CSRs that are configured as performance counters, thus performing the tracking of the number of accesses along with buffering the counter value that represents total number of memory bus accesses for each port and hardware logic module couple to that port.

Advantages of the present disclosure include, but are not limited to, providing an improved controller (e.g., IC chip) configured with firmware-accessible memory registers that are able to track the number of memory bus accesses to RAM on a per-port, per-hardware logic module basis. Because the memory registers are accessible by the firmware, the firmware operations can include the tracked number of memory accesses from the hardware registers as additional performance data, which provides insight into latencies causes by sharing the RAM memory bus with various hardware logic modules. By having this additional performance data associated with shared accesses of the memory bus, troubleshooting associated with the CPU firmware can include external latencies causes by the hardware logic modules accessing the RAM memory bus. If a significant latency issue arises with a hardware logic module instead of the firmware, additional troubleshooting operations can be performed with reference to the hardware logic module, e.g., the root cause of the problematic latency. These and other advantages will be apparent to those skilled in the art when reviewing the description of the following figures.

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IOT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to different types of memory sub-system 110. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller, CXL controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a compute express link (CXL) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access the memory components (e.g., memory devices 130) when the memory sub-system 110 is coupled with the host system 120 by the physical host interface (e.g., PCIe or CXL bus). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include not-and (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), and quad-level cells (QLCs), can store multiple bits per cell. In some embodiments, each of the memory devices 130 can include one or more arrays of memory cells such as SLCs, MLCs, TLCs, QLCs, or any combination of such. In some embodiments, a particular memory device can include an SLC portion, and an MLC portion, a TLC portion, or a QLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), not-or (NOR) flash memory, electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processor 117 (e.g., a processing device) configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, a memory device 130 is a managed memory device, which is a raw memory device 130 having control logic (e.g., local controller 135) on the die and a controller (e.g., memory sub-system controller 115) for media management within the same memory device package. An example of a managed memory device is a managed NAND (MNAND) device. Memory device 130, for example, can represent a single die having some control logic (e.g., local media controller 135) embodied thereon. In some embodiments, one or more components of memory sub-system 110 can be omitted.

The memory sub-system 110 includes a bus load monitoring component 113 that can be used to monitor RAM memory bus accesses by a plurality of hardware logic modules. In some embodiments, the bus load monitoring component 113 includes hardware registers, hardware counters, or a combination thereof, which are coupled to and capable of tracking the number of RAM memory bus accesses by each hardware logic module on a per-port basis. In some embodiments, the bus load monitoring component 113 is part of the host system 110, an application, or an operating system. In other embodiments, local media controller 135 includes at least a portion of bus load monitoring component 113 and is configured to perform the functionality described herein.

While processing the memory access commands, the memory sub-system 110 can experience quality of service issues, such a latency caused by defects in the memory sub-system software, firmware, and/or hardware. Debugging can involve finding and reducing the number of defects. Various debugging techniques can be used to detect anomalies, assess their impact, and schedule hardware changes, firmware upgrades, or full updates to a system. The goals of debugging include identifying and rectifying defects in the system (e.g., logical or synchronization problems in the firmware, or a design error in the hardware) by analyzing the system state information, which can include various data related to the operation of the memory sub-system 110.

One example of system state information can include event data generated in the memory sub-system. An event, as used herein, generally refers to a detectable change of state caused by an action performed by hardware, software, and/or firmware in the memory sub-system. Examples of events include a memory sub-system controller sending and/or receiving data or accessing a memory location of a memory device, a warning related to some reliability statistic (e.g., raw bit error rate (RBER), wear leveling, etc.) of a memory device, an error experienced by the memory sub-system controller in reading data from or writing data to a memory device, garbage collection, encoding and/or decoding, retrieving memory access commands from a queue(s) (e.g., a scheduling queue, a submission queue, etc.), data reconstruction, direct memory access (DMA) operations, media scans, or any other event relating to memory access operations. Data relating to the event can include time data (e.g., a timestamp of when execution of the event began, a timestamp of when execution of the event concluded, timer data relating to the duration of executing the event, etc.), metric data (e.g., data relating to metrics used by the memory sub-system), error handling data (e.g., types of error handling operations performed), queueing data, etc.

Point-in-time debug information can be important to analyzing events being reported from customer use and/or during the qualification of the memory sub-system 110 (e.g., an SSD). Debug information can include a snapshot of the state of the memory sub-system taken during the time that the reported issue occurred (e.g., an error or a failure). In particular, a snapshot can save the state of memory device registers, the memory, and other critical data area. Analyzing the debug information can help determine the root cause of the issue. In order to create a snapshot, each CPU core saves its hardware registers and/or other important regions of memory.

In some systems, the memory sub-system can be configured to generate multiple snapshots (periodic snapshots, snapshots during a specified time range, etc.) to sample event data from the memory sub-system and store the captured data in a data structure (e.g., a log file). The memory sub-system can then send the log to the host system for analysis. For example, the host system can analyze the log data (such as timestamp data) to determine whether and when latency issues occurred.

However, sampling via multiple snapshots can cause significant latency issues in the memory sub-system. For example, sampling can consume thousands of instruction cycles for capturing and extracting the debug information. Furthermore, sending, to the host system 120, the log file that contains data relating to thousands of snapshots can consume additional instruction cycles, which further increases the experienced latency.

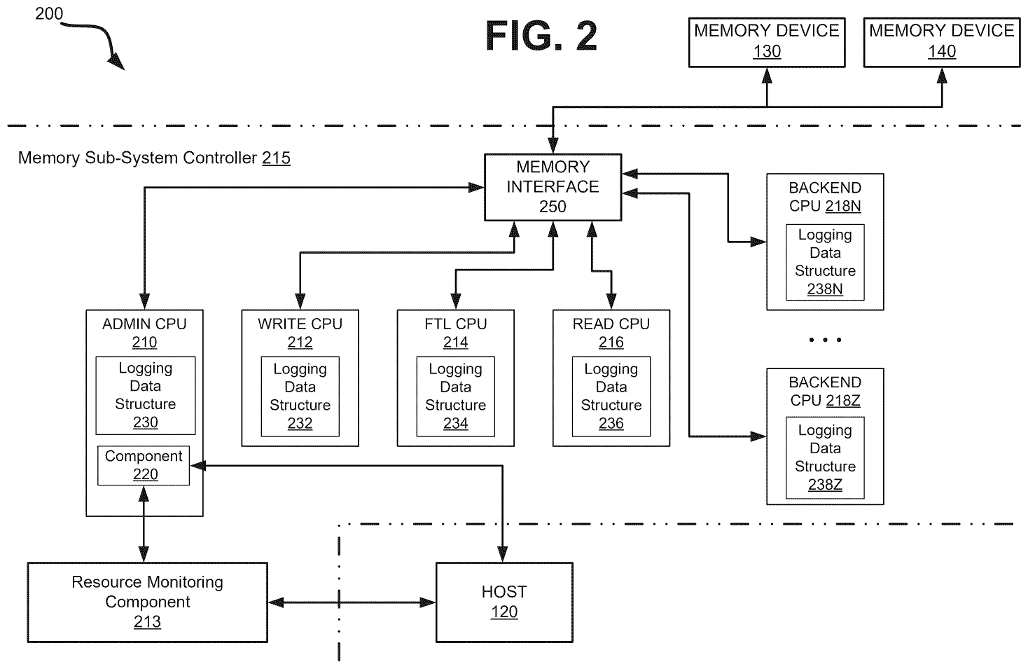

In some implementations, debugging operations or other analyses of the memory sub-system 110 can be performed on a separate computing device, such as a host system, communicably coupled to the memory sub-system through a communication channel. The communication channel can be implemented, for example, by a universal asynchronous receiver-transmitter (UART) bus, an inter-integrated circuit (I2C) bus, a system management bus (SMBus), a Nexus bus, a peripheral component interconnect express (PCIe) bus, or some other type of communication mechanism. Depending on the type of communication pipe used, the available bandwidth can vary, and only a fixed amount of system state information can be transferred over the communication pipe to the host system in a given amount of time. Thus, certain communication pipes can be considered to have limited bandwidth since they may not be able to adequately transfer all of the event entries generated in the memory sub-system. For example, a communication pipe having limited bandwidth may have a bandwidth that is below a certain threshold, or that is below a bandwidth level required to transfer a certain amount of data (e.g., the total size of all available event entries in the memory sub-system) within a fixed amount of time. When conventional systems attempt to transfer all of the event entries to the host system for debugging, certain event entries are dropped or delayed, potentially including critical or important event entries. In addition, other traffic in the communication pipe, such as host commands or memory sub-system data, can be delayed or dropped in favor of the system state information being transferred. Accordingly, a system capable of capturing debug information without adversely affecting the performance of the memory sub-system is desirable, as discussed with reference to FIG. 2.

FIG. 2 is a block diagram illustrating computing system 200 for monitoring and exporting system state information, in accordance with some embodiments of the present disclosure. Computing system 200 is a more detailed view of computing system 100. Computing system 200 can include a memory sub-system controller 215 that is operatively coupled to the memory device 130, the memory device 140, and the host system 120, which were discussed with reference to FIG. 1.

In embodiments, the memory sub-system controller 215 includes one or more frontend CPUs (e.g., administrative CPU 210, I/O write CPU 212, flash transition layer CPU or FTL CPU 214, and I/O read CPU 216), one or more backend CPUs (e.g., backend CPU 218N-218Z), a memory interface 250, and a resource monitoring component 213. Frontend CPUs can be employed to fetch and decode instructions from memory (or a cache). Backend CPUs (or execution engines) can be employed to execute the instructions. Each CPU can be assigned specific tasks and functions. Administrative CPU 210 can perform administrative tasks, such as, for example, memory partitioning, boot up operations, and the like. As will be discussed in detail below, administrative CPU 210 can include a data gathering component 220 that can be employed to monitor, collect, and export system state information. Write CPU 212 can execute write access commands received from host system 120 or memory sub-system controller 115. The FTL CPU 214 can execute maintenance tasks, such as, for example, erasing operations, wear leveling operations, random access operations, etc. Read CPU 216 can execute read access commands received from host system 120 or memory sub-system controller 115. To perform the respective tasks, each the local memory (e.g., a CPU cache, a CPU register file, local memory 119, and the like) of each CPU 210, 212, 214, 216 can include respective tasks data structure (not shown) employed to process the tasks of each corresponding CPU 210, 212, 214, 216.

In some embodiments, the local memory of each CPU 210, 212, 214, 216 can further store a respective logging data structure 230, 232, 234, 236 can store system resource data. System resource data can include any data structure or memory sub-system controller resource that the firmware of the memory sub-system is operating. More specifically, any firmware data structure residing in any memory (memory device 130, 140, local memory 119) is a resource that can be monitored. System resource data can be monitored over time. System resource data can be local to a CPU (e.g., active write location, block recovery data, etc.) or used by multiple CPUs, such as block stripe information. In some embodiments, system resource data can include metric data (e.g., data relating to metrics used by the memory sub-system), error handling data (e.g., types of error handling operations performed), queueing data, and the like.

In some embodiments, logging data structure 230, 232, 234, 236 can store statistic data. Statistics data can include custom counters that are incremented in certain scenarios. For example, a write counter can indicate the number of write access commands that were processed by write CPU 212 (e.g., the number of write access commands executed during a specific period of time, a total amount of write commands executed, etc.), a read counter can indicate the number of read access commands that were processed by read CPU 216 (e.g., the number of read access commands executed during a specific time period, a total amount of read commands executed, etc.), a counter associated with wear leveling, a counter associated with garbage collection operations, etc.

In some embodiments, logging data structure 230, 232, 234, 236 can store instruction cycle data. Monitoring instruction cycles allows resource-monitoring component 213 to capture code time execution for certain firmware processes. For example, resource-monitoring component 213 can capture the average or maximum execution time to perform FTL tasks, write access commands, read access commands, etc. Some instruction cycle data can be local to single CPU, or cross-CPUs. For example, a read access command can be initiated in the read CPU 216, and be completed in the write CPU 212. The execution time data can include a timestamp of when execution of the task began, a timestamp of when execution of the task concluded, timer data relating to the duration of executing the task, etc.

In some embodiments, each logging data structure 230-236 can be stored in the memory local memory of the CPU (e.g., CPU 210-216, respectively). The local memory can be a CPU cache, CPU register file, or the like. In other embodiments, the logging data structure 230-236 can be stored in memory device 130, 140. Each logging data structure 230-236 can be stored at a specific address range. In some embodiments, the address range associated with each data structure 230-236 can change during each boot up of the memory sub-system 110. Accordingly, during boot up, each CPU (210-216 and 218N-218Z) can send, to the resource-monitoring component 213 or data-gathering component 220, the physical address or logical address of each respective logging data structure 230-236, 238N-238Z.

Memory interface 250 can be any type of physical or logical interface capable of passing control, address, data, and other signals between the each of the frontend CPUs, each of the backend CPUs, and each of the memory devices 130, 140. In some embodiments, memory interface 250 can include a processor interface capable of performing data accesses. Memory interface 250 can map the external requests received from the host system 120 to an internal memory map. The mapping function can be configurable and the mapping information is contained in internal registers. During each retrieval period by the monitoring CPU, the monitoring CPU can translate local resource addresses into memory interface 250 addresses, read the resource data, and log it into its data structure.

Administrative CPU 210 can include data-gathering component 220. The resource monitoring component 213 can employ administrative CPU 210 as a monitoring CPU and execute a data-gathering task to retrieve system state information (e.g., system resource data, statistic data, instruction cycle data, etc.) from write CPU 212, FTL CPU 214, read CPU 216, backend CPU 218N-218Z, memory device 130, 140, and/or resource monitoring component 213. It should be noted that administrative CPU 210 is employed as a monitoring CPU by way of example, and that other CPUs can be employed to perform the tasks and functions of the monitoring CPU.

The system state information can include event data generated by each monitored CPU. Data gathering component 220 can execute the data-gathering task at a predetermined frequency (e.g., predefined interval value) (hereafter “collection period”). For example, data gathering component 220 can execute the data-gathering task responsive to a periodic expiration of a timer. The data gathering task can retrieve the system state information from each logging data structure 232-236, 238N-238Z (and/or from memory device 130, 140) using the addresses of each data structure received by the administrative CPU 210 during boot up of the memory sub-system component 110. In some embodiments, the data-gathering component 220 can retrieve and store the system state information as a log file in data structure 230. In some embodiments, each monitored CPU can generate and store the log file in its respective data structure, data-gathering component 220 can retrieve and store each log file in data structure 230. The log file can be formatted using any desired format (e.g., an executable and linkable format (ELF), JavaScript Object Notation (JSON), Extensible Markup Language (XML), YAML, etc.).

In an example, for each task executed by monitored CPU, the monitored CPU can collect and store, in its logging data structure, the system resource data (e.g., timestamps, statistics, etc.) related to the task. Upon completion of each collection period, the monitoring CPU (e.g., CPU 210) can retrieve, from the monitored CPU's logging data structure, and store, as a log file in logging data structure 230, the system resource data. The monitoring CPU can then export the log file to host 120, and clear logging data structure 230 of the log file for the next collection period.

In some embodiments, resource-monitoring component 213 can assign, to a task, a task identification used to track system resource data associated with the task across multiple CPUs. For example, a task can begin in one monitored CPU and be completed in another monitored CPU (e.g., a read command can begin in read CPU 216 and be completed in write CPU 212). The resource-monitoring component 213 can use the task identification to track system resource data resource data associated with the task as it is processed by multiple CPUs, then combine the system resource data in the log file.

In some embodiments, the data-gathering task can be set as a low priority task. Any administrative related task to be executed administrative CPU 210 can be set to a higher priority than the data-gathering task, thus enabling administrative CPU 210 to prioritize performing administrative tasks over the data-gathering task.

In some embodiments, the data-gathering component 220 can include monitored data configuration settings used to specify which system state information is to be retrieved from each of the logging data structure 232-236, 238N-238Z and/or from memory device 130, 140. The resource-monitoring component 213 can configure the monitored data configuration settings. For example, resource-monitoring component 213 can determine which system state information is retrieved from each data structure logging 232-236, 238N-238Z and/or from memory device 130, 140 during the execution of the data-gathering task.

In some embodiments, some system state information stored and maintained by resource monitoring component 213. For example, the system state information stored and maintained by resource monitoring component 213 can include counter of read and write access commands issued, a counter of read and write access commands completed, data relating to execution duration (e.g., timestamps), etc. To retrieve this system state information, data-gathering component 220 can query the resource-monitoring component 213 to request the corresponding system state information. In some embodiments, data gathering component can retrieve data or request data from the registers of the memory sub-system 110. For example, data gathering component 220 can request a snapshot of the state of each CPU of the memory sub-system 110.

Data-gathering component 220 can send (e.g., export) the log file(s) containing the retrieved system state information, via an interface, to the host system 120 for analysis (e.g., to perform debugging operations, to determine whether and when latency issues occurred, etc.). In some embodiments, the interface can include a vendor specific debugging interface, a universal asynchronous receiver-transmitter (UART) bus, a peripheral component interconnect express (PCIe) bus, a system management bus (SMBus), an inter-integrated circuit (I2C) bus, or any other electrical bus coupling host system 120 to memory sub-system 110. Each bus can be controlled by a respective driver (e.g., a PCIe/NVMe driver, a SMBus driver, etc.). The drivers can provide programming interfaces to control and manage the corresponding ports of the host system 120 and memory sub-system 110. Data-gathering component 220 (or resource monitoring component 213) can access the hardware functions of the bus ports to send and receive data via the respective driver.

In some embodiments, data-gathering component 220 can export the log file, via an interface, to an external device. The external device can be coupled memory sub-system 110 via one type of interface (e.g., a vendor specific debugging interface) and to host system 120 via another interface (e.g., a universal serial bus (USB)). The external device can be used to relatively quickly retrieve the system state data from the memory sub-system 110 using include a debugging interface, then send the system state data to host 120 using an interface unassociated with communications between host system 120 and memory sub-system 110.

In some embodiments, the log file can be exported in similar or the same time intervals as the data-gathering component 220 executes the data-gathering tasks. For example, the data-gathering component 220 can retrieve the log file(s), store them in a cache in data structure 230, export the log file(s), and then execute the data-gathering task again (or export the log file(s) while executing the next instance of the data-gathering task. In other embodiments, the data-gathering component 220 can store log files retrieved from multiple executed data-gathering tasks, and export the log files as a batch file.

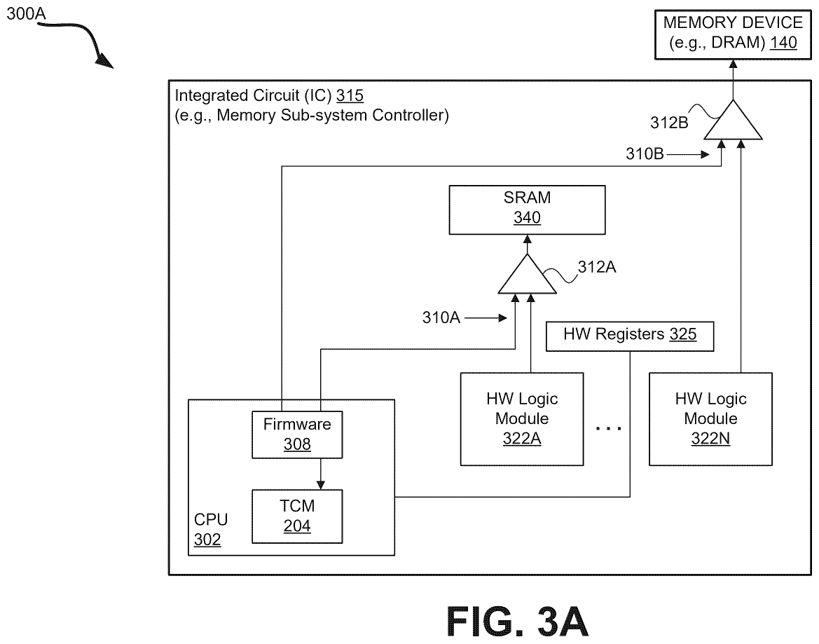

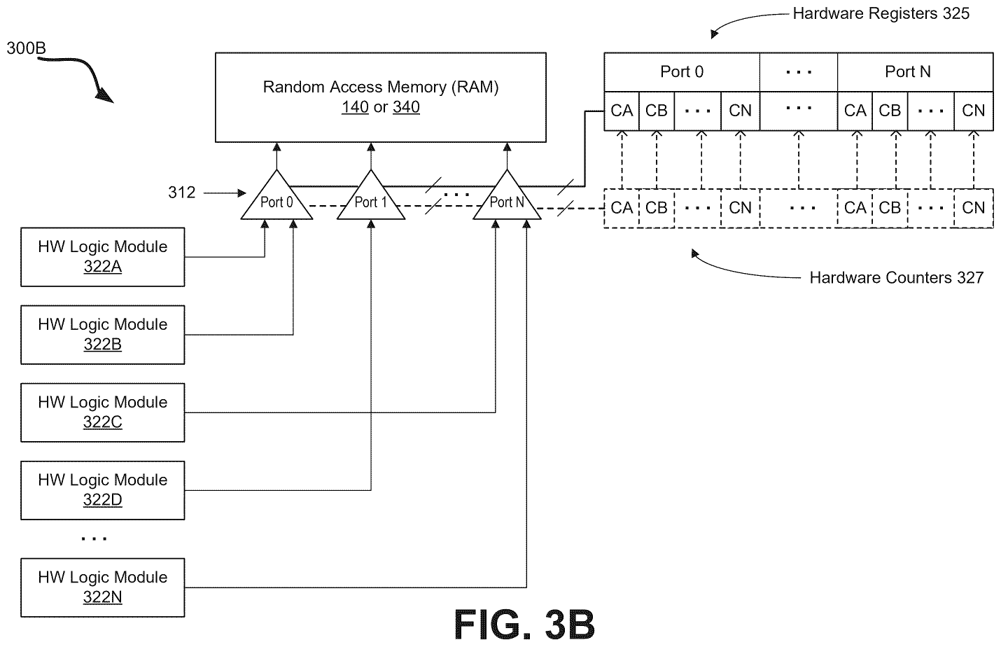

FIG. 3A is a block diagram illustrating a computing system 300A that includes an integrated circuit (IC) 315 implementing a memory sub-system controller configured to monitor a memory bus, in accordance with some embodiments. For example, the IC 315 may be employed for the memory sub-system controller 115 or 215 of FIG. 1 or FIG. 2, respectively. In various embodiments, the computing system 300A includes the memory device 140, which is coupled to the IC 315 and can include one or more DRAM dual in-line memory modules (DIMMs), for example. In different embodiments, the IC 315 is an ASIC, a programmable processor, a microcontroller, a graphic processing unit (GPU), a system-in-package (SiP), a system on a chip (SoC), or the like.

In some embodiments, the IC 315 includes a CPU 302, one or more hardware logic modules 322A-322N, an SRAM 340, and a set of hardware registers 325. For example, the hardware logic modules 322A-322N can be configured with hardware to perform specific operations related to the above-described memory access operations of the memory device 130. In some embodiments, if the IC 315 is an ASIC, the hardware logic modules 322A-322N are ASIC modules that can be supported by other ASIC hardware, e.g., which is variably referred to as hardware logic herein. Similarly, if the IC 315 is a microcontroller or SoC, the hardware logic modules 322A-322N can be microcontroller or SoC sub-modules, respectively, which can be supported by other on-chip hardware such as hardware logic referred to herein.

In embodiments, the CPU 302 is one of the CPUs 210, 212, 214, 216, or 218N-238Z discussed with reference to FIG. 2. The CPU 302 can include firmware 308, which when executed causes the CPU 302 to perform operations such as those previously discussed with reference to FIG. 2. The CPU 302 can access tightly-coupled memory or TCM 204 on-board the CPU 302 as the closest, and fastest, volatile memory in which to buffer data. In embodiments, when the TCM 204 fills up with data, the CPU 302 can seek to use the SRAM 340, and when the SRAM 340 fills up with data, the CPU 302 can seek to use the memory device 140, e.g., DRAM that is coupled externally to the IC 315.

In some embodiments, a first memory bus 310A is coupled between the CPU 302 and the SRAM 340 and a second memory bus 310B is coupled between the CPU 302 and the memory device 140. In illustrative embodiments, a first hardware logic module 322A is also coupled to and shares the first memory bus 310A while and an Nth hardware logic module 322N is coupled to and shares the second memory bus 310B. To facilitate such memory bus sharing, a first plurality of ports 312A can be coupled to the SRAM 340 to coordinate access, to the SRAM 340, by the CPU 302 and the first hardware logic module 322A. Although just the first hardware logic module 322A and the CPU 302 are illustrated, additional CPU(s) and hardware logic module(s) may also share access to the SRAM 340 via the first memory bus 310A. Further, a second plurality of ports 312B can be coupled to the memory device 140 to coordinate access, to the memory device 140, by the CPU 302 and the Nth hardware logic module 322N. Although just the Nth hardware logic module 322N and the CPU 302 are illustrated, additional CPU(s) and hardware logic module(s) may also share access to the memory device 140 via the second memory bus 310B.

In some embodiments, each of the first and second plurality of ports 312A and 312B can be data ports that are expected to facilitate exchanging data with the SRAM 340 and the memory device 140. It may be, for example, the exchange of data that most loads the first and second memory buses 310A and 310B, which loading is in need of monitoring for purposes of troubleshooting. In some embodiments, however, at least some ports of the first and second plurality of ports 312A and 312B are address ports and/or control ports. Address ports are used to specify the address of the memory location to be read from or written to the RAM and control ports are used to send control signals, e.g., which indicate type of memory operation, clock signals, and the like.

In various embodiments, the hardware registers 325 are configured to monitor each of the first plurality of ports 312A and the second plurality of ports 312B in order to track the number of accesses, to the RAM (e.g., SRAM, DRAM) being made by the hardware logic modules 322A-322N over the first and second memory buses 310A and 320, respectively. In embodiments, monitoring accesses may include tapping into the ports themselves or monitoring data being transmitted at the outputs of the ports in a way that enables distinguishing from which hardware logic module the access has originated. If monitoring the outputs from the ports, the hardware registers 325 can be enabled to detect an identifier located in data packets (or other types of packets) that identifies from which hardware logic module the data packets originate. In this way, the hardware registers 325 can determine which accesses originate from which hardware logic module for tracking purposes.

FIG. 3B is a block diagram illustrating a computing system 300B that includes the integrated IC 315 (FIG. 3A) implementing a memory sub-system controller configured to monitor a memory bus, in accordance with further embodiments. As an extension to the discussion of FIG. 3A, a plurality of hardware logic modules 322A-322N can include a first hardware logic module 322A, a second hardware logic module 322B, a third hardware logic module 322C, a fourth hardware logic module 322D, and so forth through to the Nth hardware logic module 322N. A plurality of ports 312 can represent either the first plurality of ports 312A for access to the SRAM 340 or the second plurality of ports 312B for access to the DRAM of the memory device 140.

For example, each hardware logic module can be coupled to a port of the plurality of ports 312, which enables shared access to the memory bus 310A or 310B. As illustrated, the hardware logic module 322A is coupled to the first port (Port 0), the second hardware logic module 322B is also coupled to the first port (Port 0), the third hardware logic module 322C is coupled to the Nth port (Port N), the fourth hardware logic module 322D is coupled to the second port (Port 1), and the Nth hardware logic module 322N is also coupled to the Nth port (Port N). Each of the plurality of ports 312 can cause access to be shared to a memory bus with the CPU 302, as was discussed.

In some embodiments, the plurality of hardware registers 325 are coupled to the plurality of ports 312. In such embodiments, each hardware register of the plurality of hardware registers 325 stores a number of accesses by a particular hardware logic module, of the plurality of hardware logic modules 322A-322N, through a particular port of the plurality of ports 312.

For example, as illustrated, the hardware registers 325 can be partitioned into sets of counter values for each port (e.g., Port 0, Port 1, . . . Port N), and for each port, partitioned into counter values for each hardware logic module. Thus, for example, the counter value (CA) for the first hardware logic module 322A can be stored in a first position, the counter value (CB) for the second hardware logic module 322B can be stored in a second position, and an Nth counter value (CN) for the Nth hardware logic module 322N can be stored in an Nth position. In this way, the ports can be sequentially numbered and the hardware logic modules can be sequentially numbered, enabling an ordered sequence of counter values from which the CPU 302 can read to obtain performance data associated with number of access to the memory bus 310A or 310B over time.

Thus, in some embodiments, the CPU 302 is coupled to the memory bus 310A or 310B. The first hardware logic module 322A can be coupled to the first port (Port 0), of the plurality of ports 312, to share access to the memory bus with the CPU 302. The plurality of hardware registers 325 can be coupled to the plurality of ports 312 and include a first hardware register to store a number of accesses, by the first hardware logic module 322A, to the memory bus over the first port (Port 0). For example, the first hardware register can store the counter value CA discussed previously. In embodiments, the CPU 302 is enabled access (or configured with access) to data stored in plurality of hardware registers 325, e.g., where the data is useable in load monitoring of the memory bus 310A or 310B. Further, an external CPU (not illustrated) that is coupled to the IC 315 can access the plurality of hardware registers 325 when implemented by simulation or FPGA in order to obtain performance data for troubleshooting before tape-out of the IC 315. In some embodiments, the first hardware logic module 322A is an application-specific integrated circuit (ASIC)-based module of the hardware logic, and the plurality of ports 312 and hardware registers 325 comprise ASIC-based hardware.

In some embodiments, although not specifically illustrated, the second hardware logic module 322B is coupled to the second port (Port 1), of the plurality of ports 312, to share access to the memory bus with the CPU 302 and the first hardware logic module 322A. A second hardware register, of the plurality of hardware registers 325, can store a second number of accesses, by the second hardware logic module 322B, to the memory bus over the second port.

In other embodiments, the second hardware logic module 322B is coupled to the first port (Port 0) to share access to the memory bus with the CPU 302 and the first hardware logic module 322A. The second hardware register, of the plurality of hardware registers 325, can store a second number of accesses, by the second hardware logic module 322B, to the memory bus over the first port.

In some embodiments, the plurality of hardware registers 325 are control and status registers (CSRs) configured as performance counters, e.g., are CSRs that include hardware counters capable of tracking performance events, in this case, memory bus accesses. In embodiments, each CSR of the plurality of CSRs is configured to count a threshold number of accesses to the memory bus 310A or 310B by a coupled hardware logic module and increment a counter to an incremented value. So, for example, if the threshold number of accesses is one thousand, the CSR tracking the first hardware logic module 322A at the first port would increment its counter value (Port 0, CA) by one in response to detecting the one-thousandth access. In similar fashion, the each CSR of the plurality of hardware registers 325 can track accesses (as counter values), via a different port, by one or more hardware logic module(s) over time. In embodiments, the CPU 302 is enabled access (or configured with access) to data stored in plurality of hardware registers 325, e.g., where the data is useable in load monitoring of the memory bus 310A or 310B.

In optional additional embodiments, the plurality of hardware registers 325 are not CSRs and thus rely on a plurality of hardware counters 327, which are respectively coupled between the plurality of ports 312 and the plurality of hardware registers 325, to track the accesses to the memory bus 310A or 310B. As the plurality of hardware counters 327 update counter values for a port and hardware logic module (similarly as was discussed with reference to the CSRs), hardware logic of the IC 315 can update the corresponding hardware registers of the plurality of hardware registers 325 with the updated counter values. In this way, each hardware counter of the plurality of hardware counters 327 is configured to count a threshold number of memory accesses, via a particular port of the plurality of ports 312, by a particular hardware logic module, and increment the hardware counter to an incremented value, e.g., based on the counter detecting the threshold number of accesses. The hardware logic can then store the incremented value in the corresponding hardware register, e.g., from a first hardware counter to a first hardware register that stores the counter value CA, or from a second hardware counter to a second hardware register that stores the counter value CB.

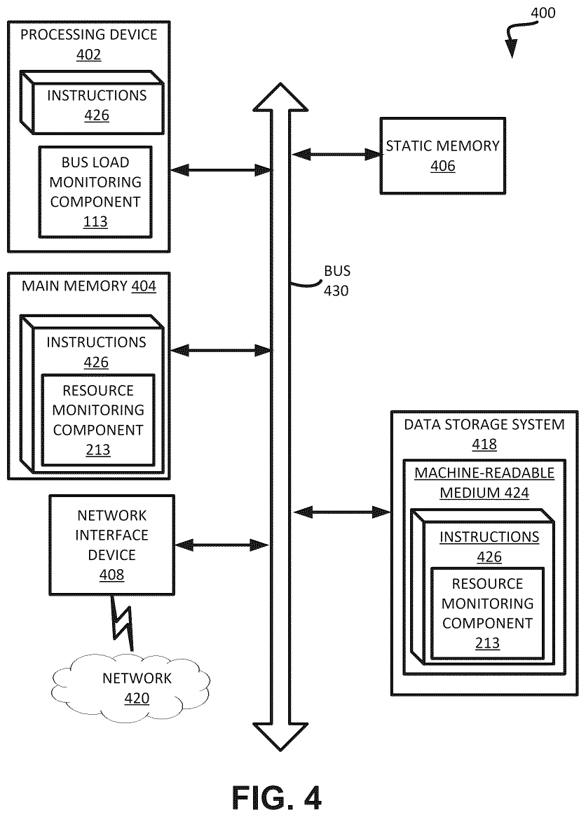

FIG. 4 illustrates an example machine of a computer system 400 within which a set of instructions, for causing the machine to perform any one or more of the methodologies discussed herein, can be executed. In some embodiments, the computer system 400 can correspond to a host system (e.g., the host system 120 of FIG. 1) that includes or utilizes a memory sub-system (e.g., the memory sub-system 110 of FIG. 1) or can be used to perform the operations of a controller (e.g., to execute an operating system to perform operations corresponding to the bus load monitoring component 113 of FIG. 1 and/or resource monitoring component 213 of FIG. 2). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 400 includes a processing device 402, a main memory 404 (e.g., read-only memory (ROM), flash memory, dynamic random access memory (DRAM) such as synchronous DRAM (SDRAM) or Rambus DRAM (RDRAM), etc.), a static memory 406 (e.g., flash memory, static random access memory (SRAM), etc.), and a data storage system 418, which communicate with each other via a bus 430. Processing device 402 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 402 can also be one or more special-purpose processing devices such as an application specific integrated circuit (ASIC), a field programmable gate array (FPGA), a digital signal processor (DSP), network processor, or the like. The processing device 402 is employed to execute instructions 426 for performing the operations and steps discussed herein. The computer system 400 can further include a network interface device 408 to communicate over the network 420.

The data storage system 418 can include a machine-readable storage medium 424 (also known as a computer-readable medium) on which is stored one or more sets of instructions 426 or software embodying any one or more of the methodologies or functions described herein. The instructions 426 can also reside, completely or at least partially, within the main memory 404 and/or within the processing device 402 during execution thereof by the computer system 400, the main memory 404 and the processing device 402 also constituting machine-readable storage media. The machine-readable storage medium 424, data storage system 418, and/or main memory 404 can correspond to the memory sub-system 110 of FIG. 1.

In one embodiment, the instructions 426 include instructions to implement functionality corresponding to resource-monitoring component 213 of FIG. 1 and/or data-gathering component 220 of FIG. 2. While the machine-readable storage medium 424 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. An integrated circuit comprising:
a memory bus coupled to a random access memory (RAM);
a plurality of ports that enable a plurality of hardware logic modules to access the RAM over the memory bus;
a central processing unit (CPU) coupled to the memory bus;
a first hardware logic module, of the plurality of hardware logic modules, coupled to a first port, of the plurality of ports, to share access to the memory bus with the CPU and others of the plurality of hardware logic modules; and
a plurality of hardware registers, coupled to the plurality of ports, comprising a first hardware register to store a number of accesses, by the first hardware logic module, to the memory bus over only the first port.

2. The integrated circuit of claim 1, wherein the CPU is enabled access to data stored in the plurality of hardware registers, wherein the data is useable in load monitoring of the memory bus.

3. The integrated circuit of claim 1, further comprising the RAM, which is static RAM.

4. The integrated circuit of claim 1, wherein the first hardware logic module is an application-specific integrated circuit (ASIC)-based module of the plurality of hardware logic modules, and wherein the plurality of ports and hardware registers comprise ASIC-based hardware.

5. The integrated circuit of claim 1, wherein the plurality of hardware registers comprises a plurality of control and status registers (CSRs) configured as performance counters, wherein a CSR of the plurality of CSRs is to:
count a threshold number of accesses to the memory bus by the first hardware logic module; and
increment a counter to an incremented value.

6. The integrated circuit of claim 1, further comprising the plurality of hardware logic modules and a plurality of hardware counters coupled between the plurality of ports and the plurality of hardware registers, wherein a hardware counter of the plurality of hardware counters is configured to:
count a threshold number of memory accesses by the first hardware logic module; and
increment the hardware counter to an incremented value; and
wherein the first hardware logic module is further to store the incremented value in the first hardware register.

7. The integrated circuit of claim 1, further comprising:
a second hardware logic module coupled to a second port, of the plurality of ports, to share access to the memory bus with the CPU and the first hardware logic module; and
a second hardware register, of the plurality of hardware registers, to store a second number of accesses, by the second hardware logic module, to the memory bus over the second port.

8. The integrated circuit of claim 1, further comprising:
a second hardware logic module coupled to the first port to share access to the memory bus with the CPU and the first hardware logic module; and
a second hardware register, of the plurality of hardware registers, to store a second number of accesses, by the second hardware logic module, to the memory bus over the first port.

9. A system comprising:
a random access memory (RAM);
a memory bus coupled to the RAM;
a plurality of ports that enable hardware logic to access the RAM over the memory bus;
a plurality of hardware logic modules, each coupled to a port of the plurality of ports, which enables shared access to the memory bus; and
a plurality of hardware registers coupled to the plurality of ports, wherein each hardware register of the plurality of hardware registers is to store a number of accesses by a particular hardware logic module, of the plurality of hardware logic modules, through a particular port of the plurality of ports.

10. The system of claim 9, further comprising one or more central processing units (CPUs), each of which is coupled to and shares the memory bus with the plurality of hardware logic modules.

11. The system of claim 10, wherein each CPU of the one or more CPUs is configured with access to data stored in the plurality of hardware registers, wherein the data is useable in load monitoring of the memory bus.

12. The system of claim 9, wherein the RAM is at least one of static RAM or dynamic RAM.

13. The system of claim 9, wherein the plurality of hardware logic modules are each an application-specific integrated circuit (ASIC)-based module of the hardware logic, and wherein the plurality of ports and hardware registers comprise ASIC-based hardware.

14. The system of claim 9, wherein the plurality of hardware registers comprises a plurality of control and status registers (CSRs) configured as performance counters, wherein a CSR of the plurality of CSRs is to:
count a threshold number of accesses to the memory bus by a first hardware logic module of the plurality of hardware logic modules; and
increment a counter to an incremented value.

15. The system of claim 9, further comprising the hardware logic and a plurality of hardware counters coupled between the plurality of ports and the plurality of hardware registers, wherein a first hardware counter of the plurality of hardware counters is configured to:
count a threshold number of memory accesses by a first hardware logic module of the plurality of hardware logic modules; and
increment the hardware counter to an incremented value; and
wherein the hardware logic is to store the incremented value in a first hardware register of the plurality of hardware registers.

16. The system of claim 9, wherein:
a first hardware logic module, of the plurality of hardware logic modules, is coupled to a first port, of the plurality of ports; and
a first hardware register, of the plurality of hardware registers, to store a number of accesses, by the first hardware logic module, to the memory bus over the first port.

17. An integrated circuit comprising:
a memory bus coupled to a random access memory (RAM);
a plurality of ports that enable hardware logic to access the RAM over the memory bus;
a plurality of hardware logic modules, each coupled to a port of the plurality of ports, which enables shared access to the memory bus;
one or more central processing units (CPUs), each of which is coupled to the memory bus; and
a plurality of hardware registers coupled to the plurality of ports, wherein each hardware register of the plurality of hardware registers is to store a number of accesses by a particular hardware logic module, of the plurality of hardware logic modules, through a particular port of the plurality of ports.

18. The integrated circuit of claim 17, wherein each CPU of the one or more CPUs is configured with access to data stored in the plurality of hardware registers, wherein the data is useable in load monitoring of the memory bus.

19. The integrated circuit of claim 17, wherein the plurality of hardware logic modules are each an application-specific integrated circuit (ASIC)-based module of the hardware logic, and wherein the plurality of ports and hardware registers comprise ASIC-based hardware.

20. The integrated circuit of claim 17, wherein the plurality of hardware registers comprises a plurality of control and status registers (CSRs) configured as performance counters, wherein a CSR of the plurality of CSRs is to:
count a threshold number of accesses to the memory bus by a first hardware logic module of the plurality of hardware logic modules; and
increment a counter to an incremented value.
